(19) United States
(12) Patent Application Publication
(10) Pub. No.: US 2015/0275545 A1
(43) Pub. Date: Oct. 1, 2015

(54) DOOR HANDLE AND REFRIGERATOR HAVING THE SAME

(71) Applicant: Samsung Electronics Co., Ltd., Gyeonggi-do (KR)

(72) Inventors: Oun Gu Lee, Seoul (KR); Sung-Jun Cho, Gwangju (KR)

(21) Appl. No.: 14/671,945

(22) Filed: Mar. 27, 2015

(30) Foreign Application Priority Data
Mar. 28, 2014 (KR) 10-2014-0037079

(51) Int. Cl. E05B 1/00; F25D 23/00; F25D 23/02

(52) U.S. Cl. CPC E05B 1/0015; F25D 23/028; F25D 23/00; E05B 1/0053

(57) ABSTRACT

Provided are a door handle and a refrigerator having the same. The number of post-processes of a gripping portion is reduced, and a cross-section of the gripping portion is simplified so that the weight of the gripping portion is reduced and manufacturing cost of a door is reduced. The door handle includes a gripping portion in which a hollow cavity is formed. The door handle also includes supporting portions disposed at a front side of a door. The door handle further includes a connection cap that is mounted on the supporting portion and has an outside surface formed to correspond to an inside surface of the gripping portion. The connection cap is inserted into the hollow cavity formed in the gripping portion.

### CROSS-REFERENCE TO RELATED APPLICATION(S) AND CLAIM OF PRIORITY

The present application is related to and claims the benefit of Korean Patent Application No. 10-2014-0037079, filed on Mar. 28, 2014 in the Korean Intellectual Property Office, the disclosure of which is incorporated herein by reference.

### TECHNICAL FIELD

Embodiments of the present disclosure relate to a door handle having an improved assembly structure and a refrigerator having the door handle.

### BACKGROUND

A refrigerator is an apparatus that is used for the purpose of storing food at a low temperature. A refrigerator is provided to keep food refrigerated or frozen depending on a state of the food.

Refrigerators have become larger and more multifunctional as users' tastes have diversified and food lifestyles have changed. Thus, products having various configurations relating to door opening and closing methods and configurations of accommodation spaces are introduced. For example, a door of a refrigerator is configured to open and close by rotating about a hinge, and a drawer type door is provided so that an accommodation container connected to the door of the refrigerator slides in a forward direction of the refrigerator and is capable of being taken out of the refrigerator.

A handle is disposed on the door of a refrigerator to facilitate opening and closing of the door of the refrigerator. The handle includes a gripping portion and a supporting portion. The gripping portion is mounted on the supporting portion, and the supporting portion is mounted on the door of the refrigerator.

The gripping portion and the supporting portion are assembled after being manufactured separately. The gripping portion and the supporting portion are coupled to each other by a fastening structure such as screw coupling. A sliding structure is provided at the supporting portion and the door of the refrigerator so that the door of the refrigerator is easily opened. When a user manipulates the gripping portion, the door of the refrigerator is spaced apart from a main body of the refrigerator by the sliding structure and thus is easily opened.

### SUMMARY

To address the above-discussed deficiencies, it is a primary object to provide a door handle that is capable of reducing the number of post-processes of a gripping portion and a supporting portion and simplifying a cross-section of the gripping portion and a refrigerator having the door handle. Additional aspects of this disclosure will be set forth in part in the description which follows and, in part, will be obvious from the description, or may be learned by practice of the invention.

In a first embodiment, a door handle is provided. The door handle includes a gripping portion in which a hollow is formed. The door handle also includes supporting portions disposed at a front side of a door. The door handle further includes a connection cap that is mounted on the supporting portion and has an outside surface formed to correspond to an inside surface of the gripping portion. The connection cap is inserted into the hollow formed in the gripping portion.

The supporting portions are disposed at each of both ends of the gripping portion, respectively. A boss into which a fastening member is inserted is formed in an inside surface of the connection cap. The fastening member couples the supporting portion and the connection cap. The supporting portion is mounted on the front side of the door by using the fastening member. A sliding portion is connected to the supporting portion. The sliding portion is mounted on the front side of the door. The supporting portion is disposed to be rotated about a rotation shaft. The sliding portion includes a connection bracket mounted on the supporting portion. The sliding portion also includes a fixing bracket connected to the connection bracket by using the rotation shaft. The sliding portion further includes a sliding member that is slidably mounted on the fixing bracket. A rail portion on which the sliding member is seated and which slides is disposed at one side of the fixing bracket. The fixing bracket is mounted on the front side of the door by using the fastening member.

A reinforcement member formed of a metal material is embedded in the fixing bracket. A through hole through which the fastening member passes is formed in the fixing bracket, and a hole having a smaller diameter than a diameter of the through hole is formed in the reinforcement member to correspond to the through hole. Pressing protrusions that press the sliding member is disposed on the connection bracket. When the connection bracket is rotated about the rotation shaft, the sliding member is pressed by the pressing protrusions and slid along the rail portion formed on the fixing bracket.

In a second embodiment, a refrigerator is provided. The refrigerator includes a main body in which a storing space is formed. The refrigerator also includes a door that is disposed in front of the main body and is configured to open and close the storing space. The refrigerator further includes a door handle disposed in front of the door. The door handle includes a gripping portion in which a hollow is formed. The gripping portion also includes supporting portions disposed at a front side of the door and supporting both ends of the gripping portion, respectively. The gripper portion further includes a connection cap that is mounted on the supporting portions and inserted into the hollow formed in the gripping portion.

An outside surface of the connection cap is formed to correspond to a shape of an inside surface of the gripping portion. A sliding portion mounted on the door is connected to the supporting portion. The supporting portion is connected to the sliding portion by using a rotation shaft and is rotated about the rotation shaft. An interference rib is disposed at one side of the connection cap. A seating rib is disposed at one side of the supporting portion to surround an outside surface of the interference rib.

In a third embodiment, a door handle is provided. The door handle includes a gripping portion in which a hollow cavity is formed and of which an inside surface is formed to have a polygonal shape. The door handle also includes a supporting portion that supports the gripping portion to be spaced a predetermined distance apart from the door. The door handle further includes connection caps that are coupled to the supporting portion by using a fastening member, an outside surface formed to correspond to an inside surface of the gripping portion, and is inserted into each of both ends of the gripping portion.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the tem′ “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a view of an example refrigerator according to this disclosure;

FIG. 2 is a perspective view of an example door handle according to this disclosure;

FIG. 3 is an exploded perspective view of an example door handle according to this disclosure;

FIG. 4 is a perspective view of an example door handle according to this disclosure;

FIG. 5 is an exploded perspective view of an example door handle according to this disclosure;

FIG. 6 is an exploded perspective view of a part of an example handle portion according to this disclosure;

FIG. 7 is a perspective view of a part of an example handle portion according to this disclosure;

FIG. 8 is a cross-sectional view of a part of an example handle portion according to this disclosure;

FIG. 9 is a perspective view of an example handle portion and an example sliding portion according to this disclosure; and

FIG. 10 is an exploded perspective view of an example sliding portion according to this disclosure.

### DETAILED DESCRIPTION

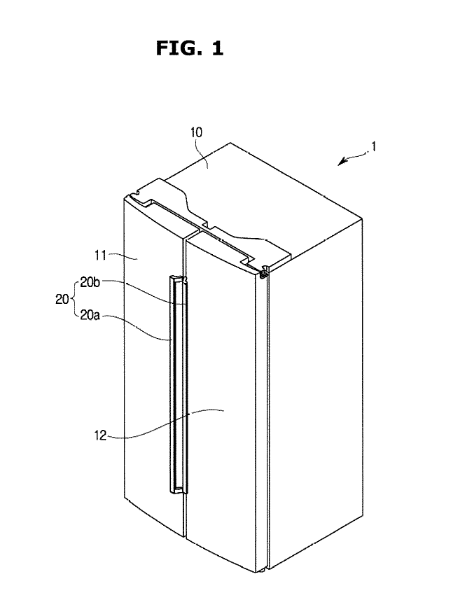

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged insulating device or container. Reference will now be made in detail to the embodiments of the present invention, examples of which are illustrated in the accompanying drawings, wherein like reference numerals refer to like elements throughout. Hereinafter, a door handle and a refrigerator having the same in accordance with an embodiment of the present disclosure will be described in detail with reference to the accompanying drawings.

FIG. 1 is a view of an example refrigerator according to this disclosure. Referring to FIG. 1, a refrigerator 1 includes a main body 10 in which a food-storing space is disposed and which has at least one side in which an opening is formed, and doors 11 and 12 that open and close the opening. An inside of the main body 10 forms one storing space, or the storing space is also divided by a barrier wall disposed in the main body 10 in a vertical direction or horizontal direction. When the inside of the main body 10 is divided into a left storing space and a right storing space by the barrier wall disposed in the vertical direction, one of the left storing space and the right storing space is a refrigerator compartment, and the other one thereof is a freezer compartment. Each of the doors 11 and 12 that open and close the refrigerator compartment or the freezer compartment is pivotally disposed in front of the main body 10.

A plurality of shelves is disposed in the refrigerator compartment or the freezer compartment. The plurality of shelves is installed so that food is efficiently placed in the refrigerator compartment or the freezer compartment. A plurality of seating ribs is formed to protrude from inner sidewalls of the refrigerator compartment or the freezer compartment, and the plurality of shelves is seated on the plurality of seating ribs and thus is fixed in the refrigerator compartment or the freezer compartment. A plurality of seating ribs is disposed to be spaced a predetermined distance from each other in the vertical direction. The shelves are disposed to be taken out of the front of the refrigerator 1. A user can easily use the shelves by changing the positions of the shelves according to the size of food or a container to be stored in the refrigerator compartment or the freezer compartment.

A door handle 20 is disposed in front of the doors 11 and 12. As illustrated in FIG. 1, when the storing space of the refrigerator 1 is divided into the left storing space and the right storing space, the door handle 20 includes a first door handle 20a disposed at the door 11 that opens and closes the left storing space and a second door handle 20b disposed at the door 12 that opens and closes the right storing space. Structures of the first door handle 20a and the second door handle 20b are disposed in a similar way. The following description of the structure of the door handle is applied to the first door handle 20a and the second door handle 20b in a similar way.

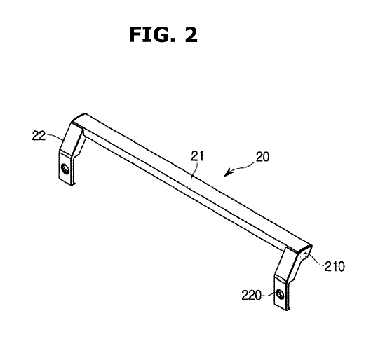

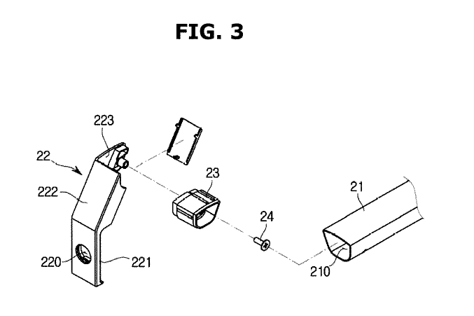

FIG. 2 is a perspective view of an example door handle according to this disclosure. FIG. 3 is an exploded perspective view of an example door handle according to this disclosure. Referring to FIGS. 2 and 3, the door handle 20 includes a gripping portion 21 and a supporting portion 22. The gripping portion 21 is mounted on a door of the refrigerator 1 using the supporting portion 22. The supporting portions 22 are mounted on both ends of the gripping portion 21.

The supporting portion 22 is fixed to one side of the door of the refrigerator 1. For example, a fastening hole 220 is formed in the supporting portion 22, and the supporting portion 22 is fixed to one side of the door using a fastening member that passes through the fastening hole 220. The gripping portion 21 is formed by extruding a metal material, such as aluminum (Al). A hollow cavity 210 is formed in the center of the gripping portion 21. An inside surface of the cross-section of the gripping portion 21 is formed to have a polygonal shape.

The supporting portion 22 includes a first supporting portion 221 in which the fastening hole 220 is formed, and a second supporting portion 222 that is formed to be bent from the first supporting portion 221 at a predetermined angle. The gripping portion 21 is mounted on the second supporting portion 222. The gripping portion 21 is disposed to be spaced a predetermined distance from one side of the door using the second supporting portion 222 that is bent at the predetermined angle and extends from the first supporting portion 221.

A third supporting portion 223 is disposed at one side of the second supporting portion 222 that extends. The third supporting portion 223 is mounted on a connection cap 23. The connection cap 23 includes a bottom portion 230 and a side portion 231 that extends from the bottom portion 230 in the vertical direction. The shape of an outside surface of the side portion 231 may correspond to the shape of the inside surface of the gripping portion 21.

The connection cap 23 is fastened to the third supporting portion 223 using a fastening member 24, and one end or the other end of the hollow cavity 210 of the gripping portion 21 is inserted into the connection cap 23. The supporting portion 22 is mounted on the refrigerator 1 in a state in which the gripping portion 21 is inserted into the connection cap 23. Thus, the door handle is mounted on the door of the refrigerator 1.

When the gripping portion 21 is directly coupled to the supporting portion 22 using the fastening member, a fastening portion to which the fastening member is coupled should be disposed at one end or the other end of the gripping portion 21. Since the gripping portion 21 is manufactured by extruding the metal material, the fastening portion is formed to extend from one end to the other end of the gripping portion 21 in a lengthwise direction of the gripping portion 21.

In this case, an extrusion material that corresponds to the thickness of the fastening portion is used, which increases manufacturing cost, and the weight of the gripping portion 21 is increased by the weight of the fastening portion, which leads to lower assembly efficiency of the door handle. Also, repetitive manipulation of the gripping portion 21 loosens fastening of the fastening member or causes a fastening defect such as the gripping portion 21 moving about the fastening member.

In the case of the door handle, one end and the other end of the gripping portion 21 are inserted into the connection cap 23, and the connection cap 23 is mounted on the supporting portion 22 so that the structure of the gripping portion 21 is simplified, manufacturing cost is reduced, and a fastening defect between the gripping portion 21 and the supporting portion 22 is prevented from occurring, or the gripping portion 21 is prevented from moving.

Since the gripping portion 21 is formed of the metal material and the supporting portion 22 is formed of a plastic injection mold, when the gripping portion 21 is directly coupled to the supporting portion 22, due to a difference in strength between the gripping portion 21 and the supporting portion 22, the supporting portion 22 connected to the gripping portion 21 is deformed or damaged due to repetitive manipulation of the door handle. The gripping portion 21 is connected to the supporting portion 22 by the connection cap 23 so that strength of the supporting portion 22 to which the gripping portion 21 is connected is reinforced and the supporting portion 22 is prevented from being deformed or damaged.

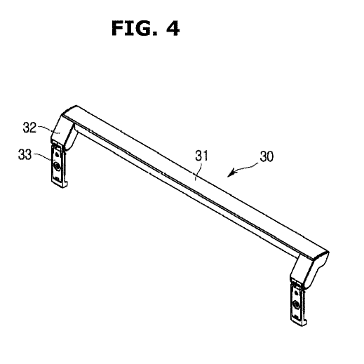

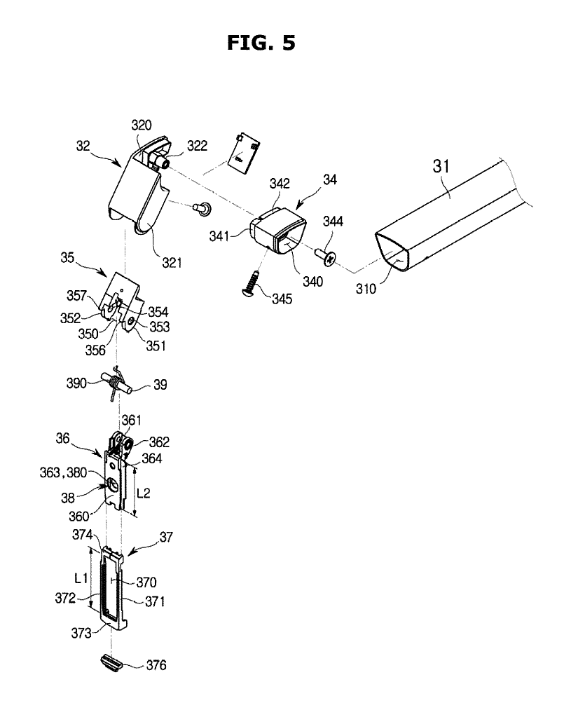

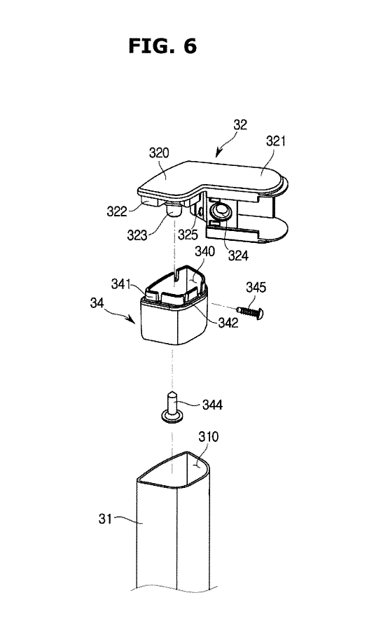

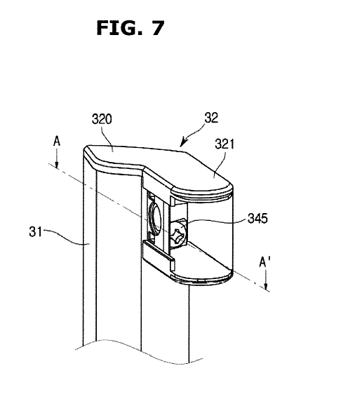

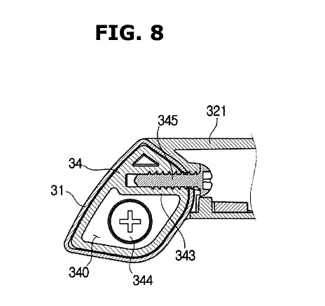

FIG. 4 is a perspective view of an example door handle according to this disclosure. FIG. 5 is an exploded perspective view of an example door handle according to this disclosure. FIG. 6 is an exploded perspective view of a part of an example handle portion according to this disclosure. FIG. 7 is a perspective view of a part of an example handle portion according to this disclosure. FIG. 8 is a cross-sectional view of a part of an example handle portion according to this disclosure.

Referring to FIGS. 4 through 8, a door handle 30 includes a gripping portion 31, a supporting portion 32, and a sliding portion. The gripping portion 31 is mounted on the supporting portion 32, the supporting portion 32 is connected to the sliding portion, and the sliding portion is mounted on a door. The sliding portion is fixed to the door, and the supporting portion 32 is disposed to be rotatable about a rotation shaft 39. When the gripping portion 31 is manipulated and the sliding portion slides to press a separation device, the door of the refrigerator 1 is spaced apart from the main body 10 by using the separation device. In this way, through a sliding structure and a pressing structure of the door handle, the door of the refrigerator 1 is easily opened with a small force.

The gripping portion 31 is disposed by extruding a metal material, such as a metal including aluminum. A hollow cavity 310 is formed in the center of the gripping portion 31. An inside surface of a cross-section of the gripping portion 31 is formed to have a polygonal shape.

The supporting portion 32 includes a first supporting portion 320 and a second supporting portion 321 connected to the first supporting portion 320. The first supporting portion 320 and the second supporting portion 321 are integrally injection-molded. The second supporting portion 321 is formed to be bent from the first supporting portion 320 at a predetermined angle. A connection cap 34 is mounted on the first supporting portion 320, and a sliding portion 33 is mounted on the second supporting portion 321.

A boss 323 is formed in one side of the first supporting portion 320. When the connection cap 34 is inserted into the first supporting portion 320, a fastening member 344 passes through the boss 323 and the connection cap 34.

A predetermined space 340 is formed in the connection cap 34. An interference rib 341 is disposed on a top end 342 of a side portion of the connection cap 34. A seating rib 322 is disposed on a bottom surface of the first supporting portion 320 so as to surround at least a part of an outside surface of the interference rib 341. The connection cap 34 is inserted into one side of the second supporting portion 321 so that at least a part of the interference rib 341 is surrounded by the seating rib 322.

A hole 325 is disposed in one side of the supporting portion 32. A boss 343 into which the fastening member 344 is inserted and coupled is disposed at one side of the connection cap 34. The boss 343 is disposed to protrude from the space 340 in the connection cap 34. A screw thread corresponding to a screw thread disposed at an outside surface of the fastening member 344 is formed in an inside surface of the boss 343. When the connection cap 34 is inserted into the first supporting portion 320, the fastening member 345 passes through the hole 325 and is inserted into and coupled to the boss 343. The supporting portion 32 and the connection cap 34 are coupled to each other using the fastening member 344 that passes through the hole 325 and is inserted into and coupled to the boss 343.

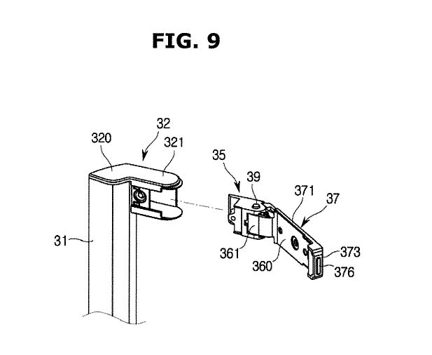

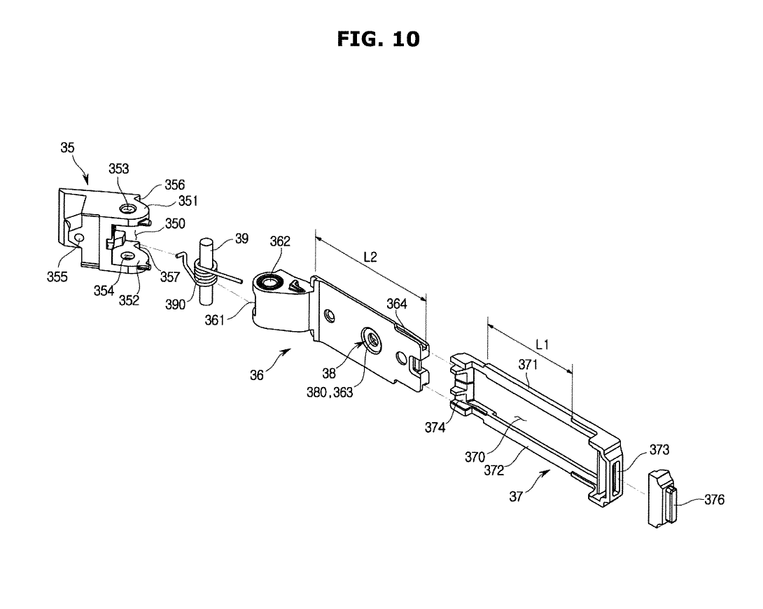

FIG. 9 is a perspective view of an example handle portion and an example sliding portion according to this disclosure. FIG. 10 is an exploded perspective view of an example sliding portion according to this disclosure.

Referring to FIGS. 9 and 10, the sliding portion includes a connection bracket 35, a fixing bracket 36, and a sliding member 37. The connection bracket 35 is mounted on the second supporting portion 321, the fixing bracket 36 is connected to the connection bracket 35 using the rotation shaft 39, and the sliding member 37 is disposed to be mounted on the fixing bracket 36 and slides along a rail portion 364 disposed on the fixing bracket 36.

Referring to FIG. 5, the connection bracket 35 is coupled to the second supporting portion 321 using a fastening member 346 that passes through fastening holes 355 and 324 formed in the connection bracket 35 and the second supporting portion 321, respectively. A first mounting portion 351 and a second mounting portion 352 is disposed at one side of the connection bracket 35 so as to be spaced a predetermined distance from each other and to face each other. A first mounting hole 353 is formed in the first mounting portion 351, and a second mounting hole 354 is formed in the second mounting portion 352.

A through hole 362 through which the rotation shaft 39 passes is formed in the fixing bracket 36. One side of the fixing bracket 36 is inserted into a space 350 between the first mounting portion 351 and the second mounting portion 352 of the connection bracket 35. The fixing bracket 36 is placed so that the through hole 362 formed in the fixing bracket 36, the first mounting hole 353 formed in the first mounting portion 351 and the second mounting hole 354 formed in the second mounting portion 352 communicate with each other. The rotation shaft 39 passes through the through hole 362, the first mounting hole 353 and the second mounting hole 354 so that the connection bracket 35 is rotatably connected to the fixing bracket 36.

An elastic member 390 is mounted on the rotation shaft 39. Even when the connection bracket 35 is rotated about the rotation shaft 39, if an external force is removed from the connection bracket 35, the connection bracket 35 is returned to its original position by an elastic force of an elastic member 390.

The fixing bracket 36 is coupled to the door of the refrigerator 1. The fixing bracket 36 includes a first bracket 360 mounted on the door of the refrigerator 1 and a second bracket 361 connected to the connection bracket 35 using the rotation shaft 39. A fixing hole 363 is formed in the second bracket 361 of the fixing bracket 36, and the fixing bracket 36 is mounted on the door using a fastening member that passes through the fixing hole 363.

A reinforcement member 38 formed of a material having a high strength is embedded in an inside of the fixing bracket 36. The reinforcement member 38 is formed of a metal material. The reinforcement member 38 is inserted into the fixing bracket 36 and is injection-molded. A hole 380 is formed in the reinforcement member 38. The hole 380 is formed in a position corresponding to the fixing hole 363 formed in the fixing bracket 36. The fastening member passes through the hole 380 and the fixing hole 363 and is fastened to the door of the refrigerator 1 to mount the fixing bracket 36 on the door of the refrigerator 1.

A diameter of the hole 380 formed in the reinforcement member 38 is formed to be smaller than a diameter of the fixing hole 363 formed in the fixing bracket 36. Thus, an outside surface of the fastening member is in contact with an inside surface of the reinforcement member 38 that forms the hole 380 in the reinforcement member 38 and may not be in contact with an inside surface of the fixing bracket 36 that forms the fixing hole 363 of the fixing bracket 36.

Thus, the strength of a coupling portion of the fastening member is reinforced. When the fastening member is disposed to be in contact with the fixing bracket 36 that is an injection mold, the fixing bracket 36 that is in contact with the fastening member is deformed or damaged due to an external force applied to the fastening member. However, the fastening member is disposed to be in contact with the reinforcement member 38 formed of the metal material having the high strength so that the fixing bracket 36 is prevented from being deformed or damaged.

The sliding member 37 is disposed to slide along a rail portion 364 disposed on the fixing bracket 36. For example, the rail portion 364 is disposed on a top surface or bottom surface of the fixing bracket 36. The rail portion 364 is disposed to extend from one end to the other end in a lengthwise direction of the fixing bracket 36. The rail portion 364 is disposed at the first bracket 360 of the fixing bracket 36. The rail portion 364 is disposed at both facing sides of the first bracket 360. The position of the rail portion 364 is not limited thereto. In the following description, it will be assumed that the rail portion 364 is disposed on a top surface or bottom surface of the fixing bracket 36.

The sliding member 37 includes a first frame 371 that slides along the rail portion 364 disposed on the top surface of the fixing bracket 36, a second frame 372 that is disposed to face the first frame 371 and slides along the rail portion 364 disposed on the bottom surface of the fixing bracket 36, a third frame 373 that connects one end of the first frame 371 and one end of the second frame 372, and a fourth frame 374 that connects the other end of the first frame 371 and the other end of the second frame 372. The first frame 371, the second frame 372, the third frame 373, and the fourth frame 374 is disposed to have an approximately rectangular shape, and a hole 370 is formed in the first frame 371, the second frame 372, the third frame 373, and the fourth frame 374.

Pressing protrusions 356 and 357 is disposed on the first mounting portion 351 or the second mounting portion 352 of the connection bracket 35 so as to press the sliding member 37. When the user applies an external force to the gripping portion 31 and the connection bracket 35 is rotated about the rotation shaft 39, the fourth frame 374 of the sliding member 37 is pressed by the pressing protrusions 356 and 357, and the sliding member 37 slides along the rail portion 364 to the right on which the third frame 373 is disposed.

A length L1 of the first frame 371 and the second frame 372 is formed to be larger than a length L2 of the first bracket 360 of the fixing bracket 36. Thus, the sliding member 37 slides a predetermined distance in a lengthwise direction of the first bracket 360 in a state in which the sliding member 37 is mounted on the first bracket 360. The third frame 373 and the fourth frame 374 serve as a stopper. The distance that the sliding member 37 slides along the first bracket 360 is limited by the third frame 373 and the fourth frame 374.

A pressing portion 376 is mounted on the third frame 373. The pressing portion 376 is disposed to press the separation device. An existing structure is applied to a structure in which the door is separated by the separation device from the main body 10, and thus a detailed description thereof will be omitted.

When the user applies the external force to the gripping portion 31 by grasping the gripping portion 31, the connection bracket 35 is rotated about the rotation shaft 39 in one direction, and the pressing protrusions 356 and 357 disposed on the connection bracket 35 presses the sliding member 37. The sliding member 37 is pressed by the pressing protrusions 356 and 357 and slides along the rail portion 364 to the right. When the sliding member 37 slides and the pressing portion 376 mounted on the third frame 373 presses the separation device in one direction, the door of the refrigerator is separated from the main body 10.

When the external force is removed from the gripping portion 31, due to the elastic force of the elastic member 390, the connection bracket 35 is rotated about the rotation shaft 39 in the other direction and is returned to its original position. When the door is closed, the pressing portion 376 is pressed by the separation device, and the connection bracket 35 is returned to its original position before the sliding member 37 slides.

The gripping portion of the door handle is mounted on the door of the refrigerator using the supporting portion. The gripping portion is disposed in the shape of a pipe in which a hollow cavity is formed in the gripping portion and a cross-section of the gripping portion has a polygonal shape. A connection cap is mounted on the supporting portion. The connection cap is inserted into the hollow cavity of the gripping portion so that the gripping portion and the supporting portion are connected to each other.

In the related art, a cutting portion is formed in a gripping portion, and protrusions is formed on a supporting portion and inserted into the cutting portion so that, even when an external force is applied to the gripping portion, the gripping portion is coupled to the supporting portion so as not to rotate. In this case, a post-process for forming the cutting portion in the gripping portion is added, which causes an increase in manufacturing cost.

Also, a gripping portion is immovably coupled to the supporting portion using a fastening member that passes through the gripping portion and the supporting portion. In this case, a fastening portion to which the fastening member will be fastened should be disposed on one end or the other end of the gripping portion. The fastening portion to which the fastening member will be fastened is formed when a part of an inside surface of the gripping portion protrudes from a hollow portion of the gripping portion. Since the gripping portion is formed by extruding a metal material, the fastening portion is formed to extend from one end to the other end in a lengthwise direction of the gripping portion. In this case, even when it is sufficient that the fastening member is disposed only on one end and the other end of the gripping portion, the shape of the fastening portion is provided in the entire cross-section of the gripping portion. Thus, manufacturing cost of the gripping portion increases, and the weight of the gripping portion is increased, leading to lower efficiency when the door handle is assembled.

The connection cap is coupled to the supporting portion, and one end and the other end of the gripping portion is inserted into the connection cap so that the supporting portion and the gripping portion is coupled to each other. In this way the number of post-processes of the gripping portion is reduced, and the configuration of the fastening portion need not be disposed at the gripping portion so that the shape of the cross-section of the gripping portion is simplified and the weight and manufacturing cost of the gripping portion is reduced.

As described above, in a door handle and a refrigerator having the same in accordance with embodiments of the present invention, the number of post-processes of a gripping portion is reduced, and a cross-section of the gripping portion is simplified so that the weight of the gripping portion is reduced and manufacturing cost of a door of the refrigerator is reduced.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A door handle comprising:
a gripping portion in which a hollow cavity is formed;
supporting portions disposed at a front side of a door; and
a connection cap mounted on the supporting portion and comprising an outside surface formed to correspond to an inside surface of the gripping portion, wherein the connection cap is inserted into the hollow cavity formed in the gripping portion.

2. The door handle of claim 1, wherein the supporting portions are disposed at both ends of the gripping portion.

3. The door handle of claim 1, wherein a boss into which a fastening member is inserted is formed in an inside surface of the connection cap.

4. The door handle of claim 3, wherein the fastening member couples the supporting portion with the connection cap.

5. The door handle of claim 1, wherein the supporting portion is mounted on the front side of the door using the fastening member.

6. The door handle of claim 1, wherein a sliding portion is connected to the supporting portion.

7. The door handle of claim 6, wherein the sliding portion is mounted on the front side of the door.

8. The door handle of claim 6, wherein the supporting portion is disposed to be rotated about a rotation shaft.

9. The door handle of claim 6, wherein the sliding portion comprises:
a connection bracket mounted on the supporting portion;
a fixing bracket connected to the connection bracket using the rotation shaft; and
a sliding member that is slidably mounted on the fixing bracket.

10. The door handle of claim 9, wherein a rail portion on which the sliding member is seated and which slides is disposed at one side of the fixing bracket.

11. The door handle of claim 9, wherein the fixing bracket is mounted on the front side of the door by using the fastening member.

12. The door handle of claim 9, wherein a reinforcement member formed of a metal material is embedded in the fixing bracket.

13. The door handle of claim 12, wherein a through hole through which the fastening member passes is formed in the fixing bracket, and a hole having a smaller diameter than a diameter of the through hole is formed in the reinforcement member to correspond to the through hole.

14. The door handle of claim 9, wherein pressing protrusions that press the sliding member are disposed on the connection bracket.

15. The door handle of claim 14, wherein, when the connection bracket is rotated about the rotation shaft, the sliding member is pressed by the pressing protrusions and slides along the rail portion formed on the fixing bracket.

16. A refrigerator comprising:
a main body in which a storing space is formed;
a door disposed in front of the main body and opens and closes the storing space; and
a door handle disposed in front of the door, wherein the door handle comprises:
a gripping portion in which a hollow cavity is formed;
supporting portions disposed at a front side of the door and supporting both ends of the gripping portion; and
a connection cap mounted on the supporting portion and inserted into the hollow cavity formed in the gripping portion.

17. The refrigerator of claim 16, wherein an outside surface of the connection cap is formed to correspond to a shape of an inside surface of the gripping portion.

18. The refrigerator of claim 16, wherein a sliding portion mounted on the door is connected to the supporting portion.

19. The refrigerator of claim 18, wherein the supporting portion is connected to the sliding portion using a rotation shaft and is rotated about the rotation shaft.

20. The refrigerator of claim 16, wherein an interference rib is disposed at one side of the connection cap, and a seating rib is disposed at one side of the supporting portion to surround an outside surface of the interference rib.

21. A door handle comprising:
a gripping portion in which a hollow cavity is formed and of which an inside surface is formed to have a polygonal shape;
a supporting portion that supports the gripping portion to be spaced a predetermined distance from the door; and
connection caps coupled to the supporting portion using a fastening member, comprise an outside surface formed to correspond to an inside surface of the gripping portion, and are inserted into both ends of the gripping portion.
